(19) United States
(12) Patent Application Publication
(10) Pub. No.: US 2006/0164356 A1
(43) Pub. Date: Jul. 27, 2006

(54) Display device and apparatus and method of driving same

(75) Inventors: Young-Chol Yang, Seongnam-si (KR); Sung-Jin Hong, Seoul (KR); Keun-Kyu Song, Seongnam-si (KR); Baek-Woon Lee, Yongin-si (KR); Mun-Pyo Hong, Seongnam-si (KR)

Correspondence Address: F. CHAU & ASSOCIATES, LLC, 130 WOODBURY ROAD, WOODBURY, NY, 11797, US

(73) Assignee: Samsung Electronics Co. Ltd.

(21) Appl. No.: 11/337,729

(22) Filed: Jan. 23, 2006

(30) Foreign Application Priority Data
Jan. 25, 2005 (KR) 10-2005-0006759

(51) Int. Cl. G09G 3/36

(52) U.S. Cl. 345/89

(57) ABSTRACT

A driving apparatus driving method of a flat panel (e.g., LCD) display device. The driving apparatus of the display device includes: a data processor that selects a (at least) two of output gray levels (output image data ) based on an input gray level (of received image data) and outputs the two output grays for each pixel to a data driver that selects two gray (reference) voltages corresponding to the output image data output from the data processor and applies the gray (reference) voltages to the pixels as data voltages. The first output gray level may be less than the second output gray level, and less than the input gray level. The first and second output gray level (and thus the first and second output grays) applied to the pixel as data voltages are optically averaged at the pixel, to have the same (average) transmittance as the original input gray level. A gray voltage generator generates and outputs a plurality of gray (reference) voltages for selection by the data driver. At least one of the plurality of gray (reference) voltages may have a value less than a liquid crystal threshold voltage.

The present application claims priority under 35 U.S.C. § 119 of Korean Patent Application No. 2005-0006759, filed on Jan. 25, 2005, the disclosure of which is hereby incorporated herein by reference in its entirety.

### BACKGROUND OF THE INVENTION

1. Field of the Invention

The present invention relates to a display device, and more particularly, to an apparatus and method of driving a liquid crystal display.

2. Description of the Related Art

In general, a liquid crystal display (LCD) includes a liquid crystal layer having dielectric anisotropy interposed between two panels, one panel having pixel electrodes and the other panel having a common electrode. The pixel electrodes are arranged in a matrix (array), and each is connected to a switching element such as a thin film transistor (TFT). The pixel electrodes sequentially receive data voltages one row at a time. The common electrode is provided the same panel as that on which the pixel electrodes are formed (or on a different panel), and receives a common voltage. The pixel electrodes, the common electrode, and the liquid crystal layer interposed therebetween form a liquid crystal LC capacitor. The liquid crystal capacitor together with a switching element connected thereto—forms a pixel.

A voltage is applied between the two electrodes to generate an electric field across the liquid crystal LC layer having dielectric anisotropy. The amplitude of the electric field across the liquid crystal controls the transmittance of light passing through the liquid crystal layer. When the plurality of pixels each have an electric field corresponding to a pixel of an image, the liquid crystal display implements the desired image.

In such a liquid crystal display, and more particularly in a liquid crystal display using a vertical electric field, optical phase retardation of the liquid crystal varies depending on viewing angle, and thus transmittance of the light at the front side of the display is different from that of the light at the lateral side of the apparatus. Thus, visibility of the front side of the display is typically much different from that of the lateral sides of the device.

The LCD includes a data driver for supplying data voltages to the pixel electrodes, which includes a shift register, a data register, a data latch, a digital-to-analog (D/A) converter, and an output buffer. The data driver latches digital image data for red (R), green (G), and blue (B) colors that are sequentially received from a timing controller in synchronization with a dot clock, converts the digital data into analog (gray) voltages, and outputs the analog (gray) voltages to the pixels. The D/A conversion of the image data into the analog (gray) voltages is performed by a D/A converter in reference to gamma reference voltages (gray voltages) received from a gray voltage generator.

A conventional LCD utilizes the same gamma reference voltages for all the three different colors under the assumption that the different-colored pixels have the same electro-optical characteristics. However, the red, green and blue pixels may actually have different electro-optical characteristics. In an attempt to improve color conception, LCDs that use separate gamma reference voltages for the respective colors have been made. An apparatus for driving a liquid crystal display may include a signal controller for generating digital signals for different pixel colors (R, G, B), and a gray voltage generator coupled to the signal controller, wherein the gray voltage generator generates (different or the same) gray voltage signals (gamma reference voltages ) for D/A converting image data of the different pixel colors. A data driver that is coupled to the gray voltage generator and to the signal controller converts each of the digital image data signals to a corresponding analog (gray) signal by selecting one of the gray voltages that is associated with the gray level of the digital image data signal (of any pixel color) that is being converted. Thus a liquid crystal panel assembly may include a data driver for supplying analog data (voltage) signals to the pixel electrodes and a gray voltage generator that is coupled to the data driver. The gray voltage generator generates a plurality of gray (reference) voltages each of which is associated with one gray level of the digital image data signal (of any pixel color). The data driver determines a particular data signal (gray voltage) to be transmitted on a particular pixel electrode, by selecting the gray (reference) voltage that is associated with the received digital image data signal (and associated with the particular pixel electrode). Using individual gamma reference voltages for the red, green and blue colors facilitates adjustment of color temperature and color coordinates. The adjustment of the color temperature and the color coordinates enlarges the color representation, which may be limited by the liquid crystal characteristics and color filters, to realize the various color representations.

In the liquid crystal display, when the transmittance of the light of each gray level is measured, the transmittance of the light gradually increases from the front side to the lateral side of the device in a low (dark) gray, and the transmittance of the light gradually decreases from the front side to the lateral side of the device in a high (whiter) gray. Thus, since the transmittance of the light varies depending on the viewing angle, the transmittance difference between the grays is reduced from the front side to the lateral side of the device, thereby deteriorating the visibility.

In order to reduce the visibility reduction at the lateral sides of the display, a method of dividing one pixel into two sub-pixels and connecting liquid crystal capacitors of the sub-pixels to a capacitor or periodically applying a fixed voltage to either one of the sub-pixels (to differentiate the voltages applied in each of the two liquid crystal capacitors so that the visibility is improved at the lateral sides) has been suggested.

However, in this method, since the ratio between the voltages charged in the two liquid crystal capacitors depends upon the capacities of several capacitors, a voltage suitable for each gray cannot be applied and thus there is a limit in improving the visibility.

### SUMMARY OF THE INVENTION

An aspect of the invention, provides an apparatus that performs a method of driving a display including a pixel (e.g., among a plurality of pixels in an array), the method comprising: receiving a digital image data indicating the luminance (gray) level to be displayed by the pixel; converting the digital image data into a pair of a first luminance (gray) level and second luminance (gray) level. The first luminance (gray) level may be lower than the second luminance (gray) level. The first luminance (gray) level and second luminance (gray) level are paired based upon values stored in a lookup table. The first and second luminance (gray) levels are converted into a first and a second analog gray voltage.

A gray voltage generator generates a plurality of gray reference voltages, and each of the first gray voltage and the second gray voltage is based upon a selection from the plurality of gray reference voltages. At least one of the plurality of gray reference voltages may have a value less than a liquid crystal threshold voltage.

The first analog gray voltage is conducted (e.g., by a data driver via a data line) to the pixel before the second analog gray voltage is conducted to the pixel, in a time division mode of operation. In a space division mode of operation, the pixel includes a first subpixel and a second subpixel, and the first analog gray voltage is conducted to the first subpixel and the second analog gray voltage is conducted to the subpixel. The average front-side transmittance due to the combination of first and second output grays in a pixel may be substantially identical to the front-side transmittance in the pixel due to the (original) input gray.

Various aspects of the present invention provides a display device and a driving apparatus of the display device, that reduces a visibility difference between the front side and the lateral side of a LCD display and improves the image quality of the display device.

Another aspect of the present invention provides a display device and a driving apparatus of the display device that improve a response speed of the liquid crystal.

According to an aspect of the present invention, there is provided a driving apparatus that drives a display device including a plurality of pixels, including: a data processor that selects a plurality (e.g., first and second) of (digital) output grays (e.g., using a look-up table) based on a (digital) input gray of external (received) input image data and outputs a plurality (e.g., first and second) of output grays (output image data); a gray voltage generator that generates and outputs a plurality of gray (reference) voltages; and a data driver that selects the gray (reference) voltages corresponding to the output image data output from the data processor from among the plurality of gray (reference) voltages and applies the gray voltages to the pixels as pixel data voltages. At least one of the plurality of gray (reference) voltages has a value less than a liquid crystal threshold voltage. The range of the grays may be gray 0 to gray 255.

In the above aspect of the prevent invention, the gray (reference) voltages corresponding to gray 0 to gray 180 among the plurality of gray voltages may have values less than the liquid crystal threshold voltage. And, at least one of the plurality of gray voltages may correspond to a gray belonging to a saturation region. Furthermore, the range of the grays belonging to the saturation region may be gray 230 to gray 255.

The change amount of transmittance (%) to a voltage V applied to liquid crystal in the saturation region may be 20%/V or less.

The gray voltage generator may include a plurality of resistors connected in series to a driving voltage. The value of the gray voltages generated by gray voltage generator may be adjusted by changing the resistance values of the resistors therein or by adjusting the value of the driving voltage.

The plurality of (e.g., first and second) output grays may be combined, in the pixels, that to form an average lateral-side gamma curve most similar to a front-side gamma curve. A pair of grays may be combined to form an average front-side transmittance substantially identical to front-side transmittance of the input gray.

The output grays may include an “upper” output gray having a value greater than the input gray and a “lower” output gray having a value less than the input gray. Thus the output image data may include upper output image data having the upper output gray and lower output image data having the lower output gray.

According to another aspect of the present invention, there is provided a display device including: a plurality of pixels (each pixel including a switching element); a plurality of gate lines that send gate signals to the switching elements; a plurality of data lines each connected to one o the switching elements; a data controller configured to select a plurality (e.g., first and second) of output grays selected (and paired) based on an input gray of external (received) input image data. The data controller sends a plurality (first and second) of output image data having respective (first and second) output grays; a gray voltage generator configured to generate and output a plurality of gray (reference) voltages; and a data driver that selects the (two) gray (reference) voltages corresponding to the (first and second) output image data output from the data processor from the plurality of gray (reference) voltages and applies the (first and second) gray voltages to a pixel as data voltages, At least one of the plurality of gray (reference) voltages may have a value less than a liquid crystal threshold voltage.

The range of the grays may be gray 0 to gray 255. In the above aspect of the prevent invention, the gray (reference) voltages corresponding to gray 0 to gray 80 among the plurality (e.g., 256) of gray voltages may have values less than the liquid crystal threshold voltage.

Additionally, at least one of the plurality of gray (reference) voltages may correspond to the gray belonging to a saturation region. The range of the grays belonging to the saturation region may be gray 230 to gray 255.

The percent change amount of transmittance (%) of a pixel due to a voltage V applied to liquid crystal in the saturation region may be 20%/V or less.

The first and second output grays for each pixel may be a optically combined in each of the pixels to form an average lateral-side gamma curve most similar to a front-side gamma curve.

### BRIEF DESCRIPTION OF THE DRAWINGS

The above and other features of the present invention will become more apparent to persons skilled in the art by describing in detail exemplary embodiments thereof with reference to the attached drawings. Hereinafter, exemplary embodiments of the present invention will be described in detail with reference to the attached drawings such that the present invention can be easily put into practice by those skilled in the art.

In the drawings, thicknesses are enlarged for the purpose of clearly illustrating layers and areas. In addition, like elements are denoted by like reference numerals in the entire specification. If it is mentioned that a layer, a film, an area, or a plate is placed on a second element, it includes a case that the layer, film, area, or plate is placed directly on the second element, as well as the case that a third element is disposed therebetween. If it is described that one element is placed directly on another element, it means that no third element is disposed therebetween.

Now, a display device and a driving apparatus of the display device according to an embodiment of the present invention will be described in detail with reference to the accompanying drawings, in which:

FIG. 1 is a block diagram of a liquid crystal display according to an embodiment of the present invention;

FIG. 2 is an equivalent circuit diagram of one pixel of a liquid crystal display of FIG. 1;

FIG. 3 is a graph illustrating a front-side gamma curve, a lateral-side gamma curve, an average front-side gamma curve, and an average lateral-side gamma curve, in the liquid crystal display of FIG. 1;

FIGS. 4A and 4B together are a waveform diagram of a data signal applied to each pixel in the liquid crystal display of FIG. 1;

FIG. 5 is a graph illustrating the range of a gray voltage output from a gray voltage generator, where L1 represents the range of a gray voltage output from a gray voltage generator 800 in the liquid crystal display of FIG. 1, and L2 represents the range of a gray voltage output from a gray voltage generator according to the prior art;

FIG. 6 is a graph illustrating an example of a pair of an upper gray and a lower gray output based on the range of the gray voltage L1 shown in FIG. 5;

FIG. 7 is a graph illustrating an average front-side gamma curve and an average lateral-side gamma curve of the lower output gray and the upper output gray of FIG. 6, and an average front-side gamma curve S1′ and an average lateral-side gamma curve S2′ when the range of the gray voltage is not corrected; and

FIG. 8 is a circuit diagram illustrating an exemplary circuit, comprised of a series of resistors, for generating a plurality of positive gray voltages in the gray voltage generator in the liquid crystal display of FIG. 1.

### DETAILED DESCRIPTION OF THE PREFERRED EMBODIMENTS

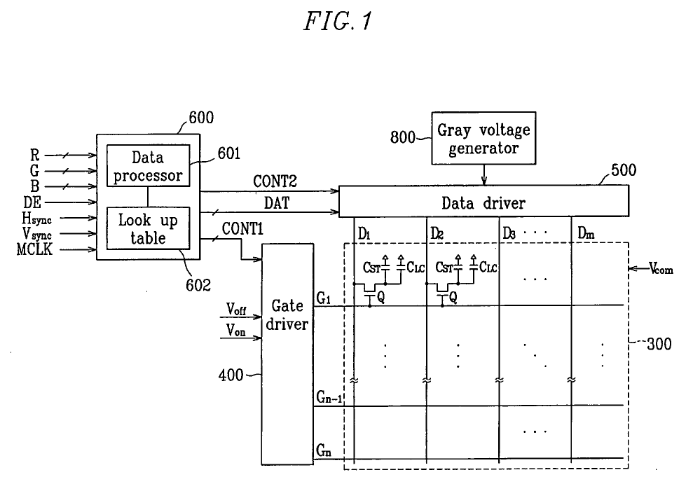

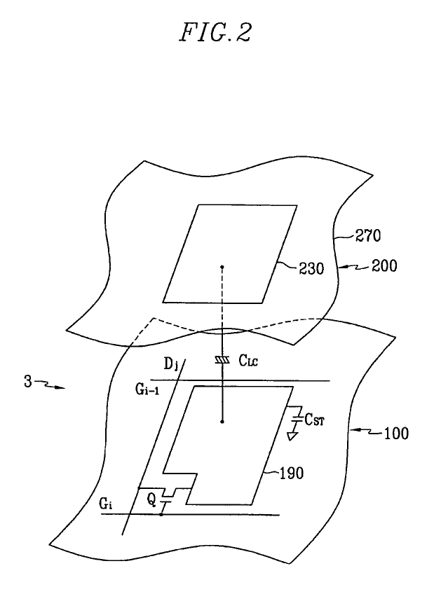

FIG. 1 is a block diagram of a liquid crystal display according to an embodiment of the present invention, and FIG. 2 is an equivalent circuit diagram of one pixel of the liquid crystal display of FIG. 1. As shown in FIG. 1, a liquid crystal display according to an exemplary embodiment of the invention includes a liquid crystal panel assembly 300 (including an array of pixels as in FIG. 2, and comprised of two panels facing each other and a liquid crystal layer having positive dielectric anisotropy interposed between the two panels), a gate driver 400 and a data driver 500 operatively connected to the liquid crystal panel assembly 300, a gray voltage generator 800 operatively connected to the data driver 500, and a signal controller 600 for controlling the gate driver 400 and the data driver 500.

The liquid crystal panel assembly 300 includes a plurality of display signal lines (gate lines G₁-Gₙ and data lines D₁-Dₘ) and a plurality of pixels (see the equivalent circuit of one pixel 3 in FIG. 2) connected to the signal lines and arranged in a matrix (pixel array).

As shown in FIG. 2, the liquid crystal panel assembly 300 includes lower and upper panels 100 and 200 which face each other and a liquid crystal layer 3 having dielectric anisotropy interposed between the panels.

The display signal lines include a plurality of gate lines G₁-Gₙ for transmitting gate signals (also referred to as scan signals) and a plurality of data lines D₁-Dₘ for transmitting data signals to individual pixels. The gate lines G₁-Gₙ substantially extend in a row (e.g., horizontal) direction and are mutually parallel, and the data lines D₁-Dₘ substantially extend in a column (e.g., vertical) direction and are perpendicular to the gate lines G₁-Gₙ.

Each pixel includes a switching element (e.g., a transistor) Q (connected one of the gate lines G₁-Gₙ and to one of the data lines D₁-Dₘ), a liquid crystal capacitor C_{LC} (operatively connected to the switching element Q, and a storage capacitor C_{ST}. The storage capacitor C_{ST} may be omitted in some embodiments.

The switching element Q of each pixel is composed of a thin film transistor TFT (e.g., formed on the lower panel 100) and is a three-terminal element having a control terminal (i.e., gate) connected to each of the gate lines G₁-Gₙ, an input terminal (i.e., source) connected to each of the data lines D₁-Dₘ, and an output terminal (i.e., drain) connected to the liquid crystal capacitor C_{LC} and to the storage capacitor C_{ST}.

The pixel electrode 190 of the lower panel 100 and the common electrode 270 of the upper panel 200 function as two terminals of the liquid crystal LC capacitor C_{ST}, and the liquid crystal layer 3 disposed between the two electrodes 190 and 270 functions as a dielectric material of the LC capacitor C_{ST}. The pixel electrode 190 is connected to the switching element Q, and the common electrode 270 is formed on the entire surface of the upper panel 200 and receives a common voltage V_{com}. Alternatively, unlike as shown in FIG. 2, the common electrode 270 may be provided on the lower panel 100. In various alternative embodiments any one of the electrodes 190 and 270 may be formed in a linear or rod shape.

The storage capacitor C_{ST} which aids the liquid crystal capacitor C_{LC} is formed by overlapping the with the pixel electrode 190 over a separate signal line (not shown) provided on the lower panel 100 with an insulator disposed therebetween. A predetermined voltage such as the common voltage V_{com} is applied to the separate signal line. However, the storage capacitor C_{ST} may also be formed by overlapping the pixel electrode 190 with the previous-stage gate line through with an insulator disposed therebetween.

In order to implement a color display, each pixel uniquely displays any one of the three primary colors (space division) or alternately displays primary colors over time (time division) to implement a desired color by the spatial or temporal sum of the primary colors. The primary colors include red, (R) green (G), and blue (B).

FIG. 2 shows an example of the space division pixel, in which each pixel includes a color filter 230 (e.g., a red, green, or a blue color filter) representing one of the primary colors (R, G or B) in a region of the upper panel 200. Alternatively, unlike as shown in FIG. 2, the color filter 230 may be formed above or below the pixel electrode 190 of the lower panel 100.

A polarizer (not shown), for polarizing the light transmitted through the pixel and through the color filter, is attached to the outer surface of at least one of the panels 100 and 200 of the liquid crystal display panel assembly 300.

Referring to FIG. 1, the gray voltage generator 800 generates gray voltages. In the exemplary embodiment, the gray voltage generator 800 generates two sets of gray voltages related to the transmittance of the pixel. A first set of gray voltages has a positive polarity and the second set of gray voltages has a negative polarity with respect to the common voltage V_{com}. A portion of the first set of gray voltages output from the gray voltage generator 800 may have a value of less than a liquid crystal threshold voltage. The gray voltage generator 800 according to the exemplary embodiment of the present invention will be described in detail later.

The gate driver 400 is connected to the gate lines G₁-Gₙ of the liquid crystal panel assembly 300, applies the gate signals (composed of a combination of a gate-ON voltage Vₒₙ and a gate-OFF voltage V_{off}) to the gate lines G₁-Gₙ, and may be composed of a plurality of integrated circuits (e.g., mounted on the liquid crystal panel assembly 300).

The data driver 500 is connected to the data lines D₁-Dₘ of the liquid crystal panel assembly 300, it selects any one from the gray voltages output from the gray voltage generator 800 to apply the selected gray voltage to the pixels as data voltages, and it may be composed of a plurality of integrated circuits (e.g., mounted on the liquid crystal panel assembly 300). The data driver 500 receives gray voltages from the gray voltage generator 800, selects data voltages among the gray voltages, and applies the data voltages to the data lines D₁-Dₘ. The data driver 500 may include a shift register (not shown), a data register (not shown), a data latch (not shown), a D/A converter (not shown), and an output buffer (not shown). The shift register stores R, G, and B data transmitted from the signal controller 600 into the data register. The D/A converter receives the data stored in the data register through the data latch and converts the data into analog data voltages. The output buffer stores the analog data voltages supplied from the D/A converter and applies the data voltages to the data lines in response to a load signal. The D/A converter of the data driver 500 receives the gray voltages from the gray voltage generator 800, and converts the stored R, G, and B data stored in the data register into analog data voltages corresponding to the gray voltages. The output buffer stores the analog data voltages supplied from the D/A converter and applies the data voltages to the data lines in response to a load signal.

The gate driver 400 or the data driver 500 may be directly mounted on the liquid crystal panel assembly 300 with a plurality of integrated circuit chips for driving, or it may be mounted on a flexible printed circuit film (not shown) to be attached to the liquid crystal panel assembly 300 in a tape carrier package form. Alternatively, the gate driver 400 or the data driver 500 may be integrated in the liquid crystal panel assembly 300 together with the display signal lines G₁-Gₙ and D₁-Dₘ and the switching element Q.

The signal controller 600 controls the operations of the gate driver 400 and of the data driver 500 and includes a data processor 601 and a lookup table 602. The data processor 601 converts input image data R, G, and B, which are externally input and have “input grays”, into lower output image data having one gray less than the input grays (hereinafter referred to as “lower output gray”) and upper output image data having one gray greater than the input grays (hereinafter referred to as “upper output gray”), using the lookup table 602.

Now, the operation of the liquid crystal display will be described in detail.

The signal controller 600 receives the input image signals R, G, and B and input control signals for controlling the display of the image signals, for example a vertical synchronization signal Vsync and a horizontal synchronization signal Hsync, a main clock signal MCLK, and a data enable signal DE, from an external graphics controller (not shown). Based on the input image signals R, G, and B and the input control signals received by the signal controller 600, the input image signals R, G, and B are processed in accordance with the operation condition of the liquid crystal panel assembly 300 to generate a gate control signal CONT1 and the data control signal CONT2. Then, the gate control signal CONT1 is transmitted to the gate driver 400, and the data control signal CONT2 and a processed output image signal DAT are transmitted to the data driver 500.

The data processing performed by the signal controller 600 includes selecting the lower and upper output grays (stored in the lookup table 602) based on the input grays of the input image data R, G, and B, assigning the selected grays to the pixels (in a space or time division method), and generating output image data. The data processing performed by the signal controller 600 in each of the space or time division modes will be described in detail below.

The gate control signal CONT1 includes a scanning start signal STV indicating scan start, and at least one clock signal for controlling output time of the gate-ON voltage Von. The gate control signal CONT1 may further include an output enable signal OE for defining the duration of the gate-ON voltage Vₒₙ.

The data control signal CONT2 includes a horizontal synchronization start signal STH that indicates that valid data is transmitted to a row of pixels, a load signal LOAD for applying the respective data voltages to the data lines D₁-Dₘ, and a data clock signal HCLK. The data control signal CONT2 may further include a reverse signal RVS for reversing the polarity of the data voltage with respect to the common voltage V_{com} (hereinafter referred to as the polarity of the data voltage).

The data driver 500 receives the image data DAT (R, G and B) from the signal controller 600 and converts the image data R, G and B into analogue data voltages selected from the gray voltages supplied from the gray voltage generator 800 in response to the data control signals CONT2 from the signal controller 600. In accordance with the data control signal CONT2 output from the signal controller 600, the data driver 500 sequentially receives and shifts the image data DAT (R, G, B) of a row of pixels, selects gray voltages corresponding to the respective image data DAT (from the gray voltages received from the gray voltage generator 800), converts the image data DAT into analog data voltages (corresponding to the gray voltages received from the gray voltage generator 800), and applies the analog data voltages to the respective data lines D₁-Dₘ.

The gate driver 400 sequentially applies the gate-ON voltage Vₒₙ to the gate lines G₁-Gₙ and turns ON the switching elements Q connected to the gate lines G₁-Gₙ in accordance with the gate control signal CONT1 output from the signal controller 600. The data voltages applied to the data lines D₁-Dₘ are applied to the respective pixels through the turned-ON switching elements Q.

The difference between the common voltage V_{com} and the data voltage applied to the data line of a pixel is applied across the pixel and appears as a charge voltage of the liquid crystal capacitor C_{LC}, that is, a pixel voltage. The arrangement (orientations) of liquid crystal molecules varies depending on the size of the pixel voltage and thus the polarization of the light passing through the liquid crystal layer 3 varies. The liquid crystal molecules have orientations depending on the magnitude of the pixel voltage and the orientations determine the polarization of light passing through the LC capacitor C_{LC}. The polarizers convert the light polarization into the light transmittance. As a result, the transmittance of the light from each pixel through the polarizer (not shown) attached to the panels 100 and 200 varies based upon the data voltage applied to the data line of each pixel.

The data driver 500 and the gate driver 400 repeatedly perform the same (above) operations within each one vertical period (or “1H”) (one period of a horizontal synchronization signal Hsync and the gate clock CPV). Within one frame, the gate-ON voltage Vₒₙ is sequentially applied to all the gate lines G₁-Gₙ and thus the data voltages are sequentially applied to all the pixels, row by row. When one frame is finished, a next frame starts, and the state of the reverse signal RVS applied to the data driver 500 is controlled such that the polarity of the data voltage applied to each pixel becomes opposite to that of the previous frame (“frame inversion”). In various embodiments, even within one frame, the polarity of the data voltage of one data line may be changed (for example row inversion or dot inversion) or the polarities of the data voltages of the adjacent data lines may be different from each other (for example column inversion or dot inversion) in accordance with the characteristics of the reverse signal RVS.

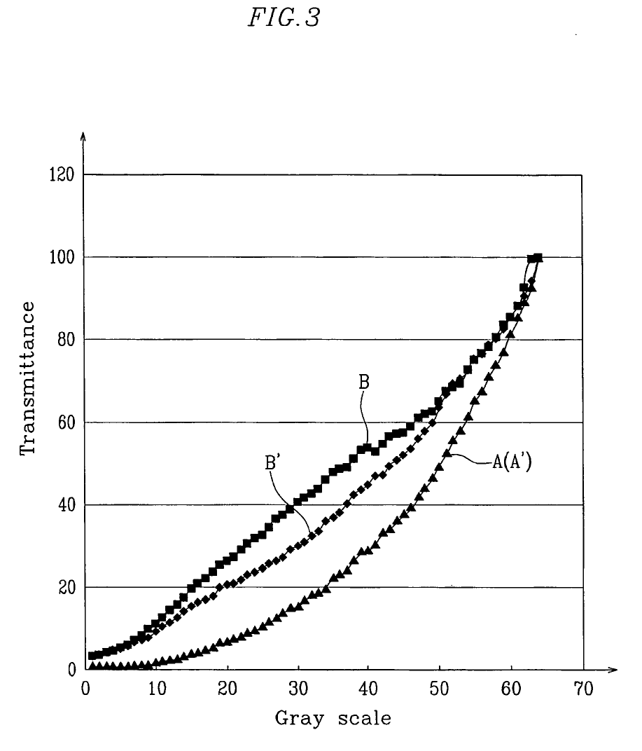

The data conversion of the data processor 601 of the signal controller 600 according to an embodiment of the present invention, will be described with reference to the attached drawings. First, the principle of converting the gray stored in the lookup table 602 will be described in detail with reference to FIG. 3.

FIG. 3 is a graph illustrating a front-side gamma curve A and a lateral-side gamma curve B before correction, and a front-side gamma curve A′ and a lateral-side gamma curve B′ after the correction, according to an embodiment of the present invention.

In FIG. 3, the transmittance of each gray is measured at the front side and the lateral side of the apparatus to obtain a front-side gamma curve A and a lateral-side gamma curve B (before correction). Next, a search is made among pairs of the lower grays and the upper grays of each gray, for pairs of lower grays and upper grays in which the average of the front-side transmittance of the lower gray and the front-side transmittance of the upper gray (hereinafter referred to as front-side average transmittance) is identical to the front-side transmittance of the original gray to form an average front-side gamma curve A′ similar to the front-side gamma curve A.

Among the pairs of the grays searched, an average of the lateral-side transmittance of the lower gray and the lateral-side transmittance of the upper gray (hereinafter referred to as lateral-side average transmittance) is calculated and the pairs of grays having the lateral-side average transmittance to forms an average lateral-side gamma curve B′ most similar to the front-side gamma curve A, are selected. Thus, among the plural pairs of upper and the lower grays of which the side-side average transmittance is identical to the front-side transmittance of the original gray, a pair of the grays which has the lowest gamma curve distortion at the lateral side of the apparatus is selected.

A pairing of a lower gray and an upper gray, that forms the average lateral-side gamma curve B′ most similar to the front-side gamma curve A for each gray, is obtained and stored in the lookup table 602 as the lower output gray and the upper output gray.

An example of the lower output gray and the upper output gray obtained for each gray is shown in Table 1. The total number of the grays shown in Table 1 is 64, however a person of ordinary skill in the art will understand that these numbers may vary depending on the number of gray voltages (e.g., 256)

TABLE 1

| | Lower | Upper |
|---|---|---|
| Orig. | output | output |
| Gray | gray | gray |
| 0 | 0 | 0 |
| 1 | 0 | 2 |
| 2 | 0 | 4 |
| 3 | 0 | 5 |
| 4 | 0 | 6 |
| 5 | 0 | 7 |
| 6 | 0 | 8 |
| 7 | 0 | 9 |
| 8 | 0 | 10 |
| 9 | 0 | 12 |
| 10 | 0 | 13 |
| 11 | 0 | 14 |
| 12 | 0 | 16 |
| 13 | 0 | 18 |
| 14 | 0 | 20 |
| 15 | 0 | 21 |
| 16 | 0 | 22 |
| 17 | 0 | 24 |
| 18 | 0 | 26 |
| 19 | 0 | 27 |
| 20 | 0 | 28 |
| 21 | 0 | 29 |
| 22 | 0 | 31 |
| 23 | 0 | 32 |
| 24 | 0 | 33 |
| 25 | 0 | 34 |
| 26 | 0 | 36 |
| 27 | 0 | 37 |
| 28 | 3 | 38 |
| 29 | 5 | 39 |
| 30 | 6 | 41 |
| 31 | 7 | 42 |
| 32 | 8 | 43 |
| 33 | 11 | 44 |
| 34 | 10 | 46 |
| 35 | 11 | 47 |
| 36 | 13 | 48 |
| 37 | 14 | 49 |
| 38 | 14 | 50 |
| 39 | 16 | 50 |
| 40 | 18 | 51 |
| 41 | 16 | 53 |
| 42 | 19 | 53 |
| 43 | 19 | 54 |
| 44 | 20 | 55 |
| 45 | 21 | 56 |
| 46 | 23 | 57 |
| 47 | 23 | 58 |
| 48 | 25 | 59 |
| 49 | 30 | 59 |
| 50 | 35 | 59 |
| 51 | 38 | 59 |
| 52 | 40 | 60 |
| 53 | 44 | 60 |
| 54 | 48 | 60 |
| 55 | 49 | 60 |
| 56 | 52 | 60 |
| 57 | 53 | 60 |
| 58 | 53 | 61 |
| 59 | 56 | 61 |
| 60 | 58 | 61 |
| 61 | 60 | 61 |
| 62 | 60 | 63 |
| 63 | 63 | 63 |

Alternatively, one (original) gray can be converted into at least two (e.g., two, three or more) output grays. In such a case, the front-side average transmittance of the grays may be made identical to the front-side transmittance of the original gray, and the average lateral-side gamma curve of the lateral-side average transmittances has a shape similar to that of the front-side gamma curve A. The output grays may have different values or at least two output grays may have the same value.

When a plurality of output grays of the input image data R, G, and B are stored in the lookup table 602 by the aforementioned method, the data processor 601 of the signal controller 600 reads the plurality of output grays corresponding to the input image data R, G, and B and assigns the output grays to the respective pixels.

The method of assigning the plurality of output grays to the respective pixels includes a space division method and a time division method.

The space division method divides one pixel into two physically proximate sub-pixels, converts the input image data of the pixel into lower output image data having the lower output gray and upper output image data having the upper output gray, and assigns each of the lower and upper output image data to one of the two sub-pixels.

By contrast, in the time division method, the frame frequency of the input image data (hereinafter referred to as input frame frequency) is different from (e.g., a fraction of) the frame frequency of the output image data (hereinafter referred to as output frame frequency), to obtain a plurality of output image data of the respective pixels in accordance with the ratio of the frequencies, and assigns the output image data to different frames.

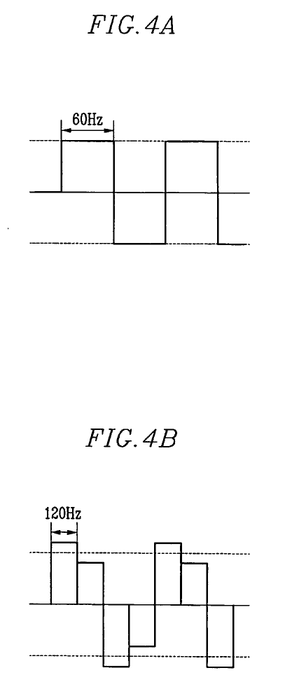

In the time division method, for example, the output frame frequency may be increased to two times the input frame frequency. The time division method will now be further described with reference to FIGS. 4A and 4B.

FIG. 4A is a waveform diagram of the data signal having the frame frequency of 60 Hz (before conversion), and FIG. 4B is a waveform diagram of the data signal having the frame frequency of 120 Hz (after conversion).

As shown in FIGS. 4A and 4B, if the input frame frequency is 60 Hz and the output frame frequency is 120 Hz, the upper and lower output grays are obtained with respect to the input (original) gray of the input image data of each pixel, and the upper and lower image data are assigned to one frame.

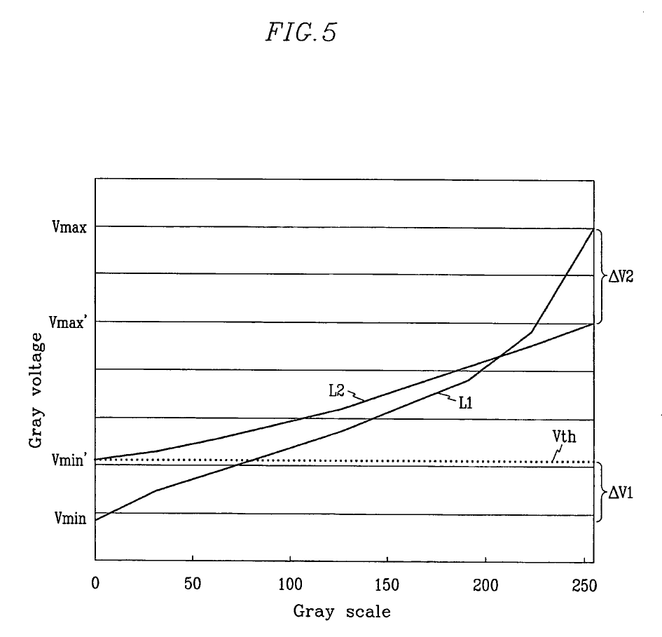

For example, as shown in FIG. 5B, the upper output image data is assigned to the pixels of a first frame, and the lower output image data is assigned to the pixels of a second frame. Alternately, the lower output image data may be assigned to the pixels of the first frame and the upper output image data may be assigned to the pixels of the second frame. The lower output image data and the upper output image data may also be assigned to pixels in other assignment orders.

In addition, in a case where the output frame frequency is an even number (e.g., greater than two) times the input frame frequency, the lower and upper output image data can be assigned to the pixels in the same manner. Furthermore, even a case where the output frame frequency is not two times the input frame frequency, the lower and upper output image data can be assigned to the pixels. Since the input grays are converted to a pair of a lower output gray and an upper output gray, which forms a lateral-side gamma curve having the shape most similar to that of the front-side gamma curve, based on the time average transmittance, and the lower and upper output grays are assigned to the pixels, deterioration of the image quality due to the visibility difference between the front side and the lateral side is reduced.

Next, the gray voltage generator 800 according to an embodiment of the present invention will be described with reference to FIGS. 5 to 7 and FIG. 1.

FIG. 5 is a graph illustrating the range of a gray voltage output from a gray voltage generator 800, where L1 represents the range of the gray voltages output from a gray voltage generator 800, and L2 represents the range of a gray voltages output from a gray voltage generator according to the prior art.

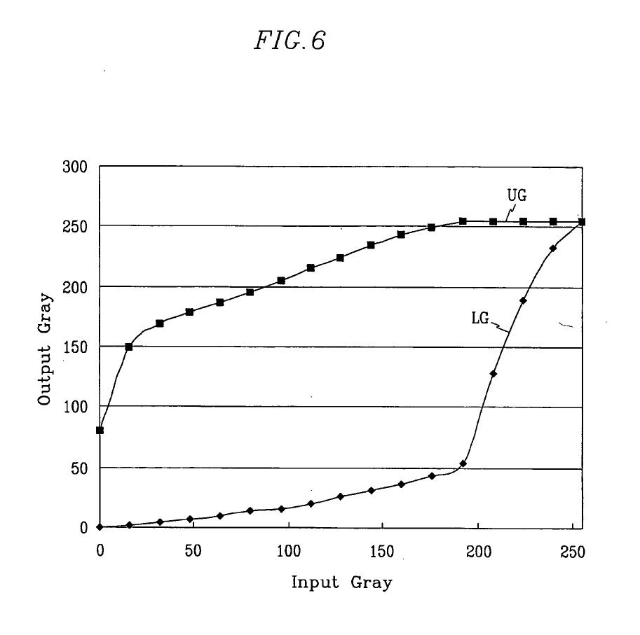

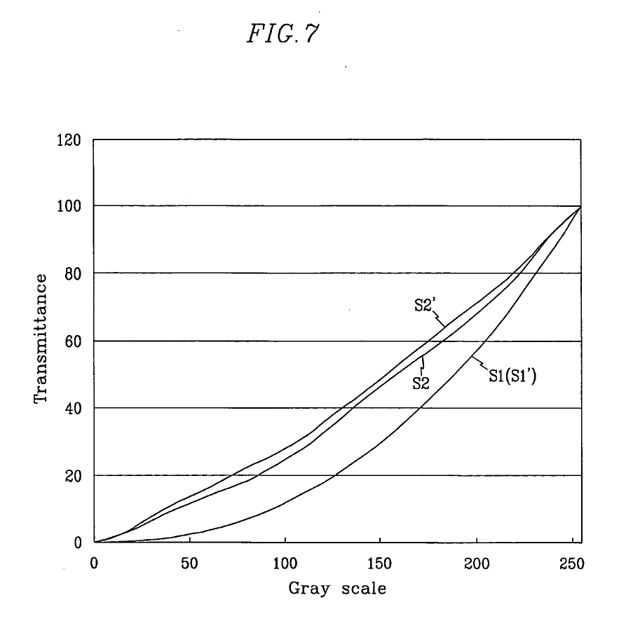

FIG. 6 is a graph illustrating an example of a pairing (pair) of an upper gray and a lower gray output based on the range of the gray voltages L1 shown in FIG. 5; and FIG. 7 is a graph illustrating an average front-side gamma curve S1 and an average lateral-side gamma curve S2 of the lower output gray and the upper output gray of FIG. 6, and an average front-side gamma curve S1′ and an average lateral-side gamma curve S2′ when the gray voltage is not corrected.

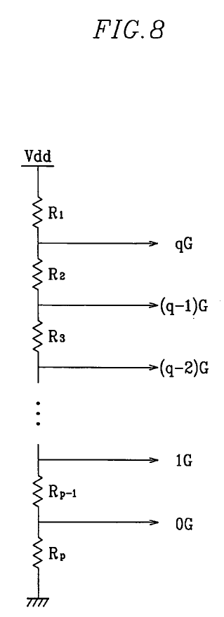

First, the structure of the gray voltage generator 800 will be described with reference to FIG. 8. FIG. 8 illustrates an example of a series of resistors for generating a plurality of positive gray voltages in the gray voltage generator 800 of FIG. 1.

As shown in FIG. 8, a plurality of voltage dividing resistors R1, R2, and Rp are connected in series between a power supply voltage Vdd and ground. The number of the voltage dividing resistors R1, R2, . . . , and Rp varies depending on the number of the gray voltages to be generated. For example, if the number of the gray voltages is 256, the number of the voltage dividing resistors is 257. However, the present invention is not limited to this simple implementation.

The power supply voltage Vdd is divided into a plurality of voltages having predetermined values predetermined by the voltage dividing resistors R1, R2, . . . , and Rp of the gray voltage generator 800 and applied to the data driver 500 as a plurality of gray voltages 0 G, 1 G, . . . , (q-2)G, (q-1)G, and qG. In a normally-black mode liquid crystal display, the lowest gray voltage 0 G is the gray voltage for “black” gray, and the highest gray voltage qG is the gray voltage for “white”.

When the plurality of gray voltages 0 G, 1 G, . . . , (q-2)G, (q-1 )G, and qG are applied, the data driver 500 selects the gray voltages corresponding to the lower output image data having the lower output gray and to the upper output image data having the upper output gray, which are applied from the signal controller 600, and applies the gray voltages to the respective pixels as the lower data voltages and the upper data voltages.

Generally, in a case where one data voltage is applied to one pixel, even if the gray is 0 which is the lowest gray for displaying black, brightness corresponding to gray 0 must be output, and thus the gray voltage at this time must have a value greater than a liquid crystal threshold voltage Vth. Accordingly, the lower limit of the gray voltage is determined to be a value in the vicinity of the liquid crystal threshold voltage with consideration of the liquid crystal threshold voltage. In addition, when the gray voltage of the highest gray unconditionally increases, the brightness increases, but the color definition is deteriorated. Thus, the gray voltage cannot unconditionally increase.

If two data voltages, (e.g., the lower data voltage and the upper data voltage), are applied to one pixel such that the average lateral-side gamma curve has a shape similar to that of the front-side gamma curve, the response speed of the liquid crystal may be slower. Thus, the pixel voltage does not reach a target voltage during a given time by applying the lower and upper output data voltage corresponding to the set lower and upper output grays, and thus the difference between the lower output gray and the upper output gray becomes smaller than a desired value. Accordingly, the difference between the average lateral-side gamma curve and the front-side gamma curve increases and thus the visibility is deteriorated.

Accordingly, it may be necessary to increase or decrease the gray voltages of the actual output grays to increase the response speed of the liquid crystal such that the pixel voltage reaches the target voltage during the given time interval.

Since the lower data voltage and the upper data voltage are applied to one pixel, although the lower data voltage or the upper data voltage more increases or decreases, the voltage change can be compensated using the other upper data voltage or the other lower data voltage. In this case, as described above, the average front-side gamma curve of the lower gray and the upper gray is identical to the front-side gamma curve of the input gray, and the average lateral-side gamma curve has a shape similar to that of the front-side gamma curve.

Accordingly, it is possible to adjust the upper limit and the lower limit of the gray voltage to widen the range of the gray voltage, and to increase the voltage difference between the grays to widen the selected range of the gray voltage.

Thus, the lower limit of the gray voltage decreases less than the liquid crystal threshold voltage and the upper limit of the gray voltage increases, thereby increasing the entire range of the gray voltage.

The gray voltage corresponding to a low gray group from gray 0 to a predetermined gray has a value less than the liquid crystal threshold voltage Vth. When the lower output gray belongs to the low gray group, the gray voltage at this time has a value less than the liquid crystal threshold voltage Vth and is applied to the pixel as the lower data voltage. The range of the low gray group is about gray 0 to gray 180, and, more preferably, gray 0 to gray 80. However, the present invention is not limited to these ranges, and selected ranges may vary depending on the number of grays or the range of the gray voltage. Since the gray voltage of the low gray group is less than the liquid crystal threshold voltage Vth, the lower limit of the gray voltage (which is limited by the liquid crystal threshold voltage Vth) decreases, and thus the range of the gray voltage becomes substantially wider. In an initial arrangement, after the liquid crystal molecules operate by the applied pixel voltage, the liquid crystal molecules operate by the applied voltage even though the applied voltage may be less than the liquid crystal threshold voltage Vth is applied.

The gray voltage of the low gray group having a value less than the liquid crystal threshold voltage Vth may be generated by adjusting the values of the plurality of voltage dividing resistors R1, R2, . . . , and Rp.

In addition, the driving voltage Vdd applied to the plurality of voltage dividing resistors R1, R2, . . . , and Rp may be increased to widen the range of the gray voltage. In this case, since the range of the gray voltage becomes wider overall, the difference between the gray voltages increases, the gray voltage of a high gray group from the predetermined gray to a highest gray increases, and the upper limit of the gray voltage increases.

The range of the high gray group may be predetermined based on a saturation region in the curve illustrating a relationship between the transmittance and the voltage applied to the liquid crystal (VT curve). This is because the response speed of the liquid crystal is slow in the saturation region. The saturation region indicates the region in which the change of the transmittance versus the applied voltage rapidly decreases in the VT curve, and preferably the region in which the change of the transmittance (%) versus the voltage V is about 20%/V (or less) when maximum transmittance is 100%. In the exemplary embodiment, the high gray group is about gray 230 to gray 255 (assuming 256 grays). However, the present invention is not limited to this range and the range may vary depending on the number of the grays or the range of the gray voltage.

As such, it is possible to adjust the resistance values of the voltage dividing resistors R1, R2, . . . , and Rp and the driving voltage Vdd to widen the range of the gray voltages of the low gray group and of the high gray group and to expand the whole range of the gray voltages, thereby applying a data voltage that is significantly less or more than the original data voltage. Accordingly, the lower gray and the upper gray may be predetermined based on the widened range of the gray voltage and the difference between the two grays may be increased such that the response speed of the liquid crystal molecules increased, thereby reducing the time that the pixel voltage reaches the target voltage.

The waveform of the gray voltage corresponding to each gray when the output range of the gray voltage is adjusted according to embodiments of the present invention will now be described with reference to FIG. 5.

In FIG. 5, the line L1 represents the gray voltage of each gray according to an exemplary embodiment of the present invention. The range of the low gray group having the value less than the liquid crystal threshold voltage Vth is about gray 0 to gray 80 (assuming 256 gray levels).

The line L2 represents the gray voltage of each gray according to the prior art (in which the grays having the value less than the liquid crystal threshold voltage Vth does not exist).

As shown in FIG. 5, since a lower limit Vmin corresponding to a minimum gray of the line L1 is lower than a lower limit Vmin′ of the line L2 by ΔV1, and an upper limit Vmax corresponding to a maximum gray of the line L1 is higher than an upper limit Vmax′ of the line L2 by ΔV2, it can be seen that the range of the gray voltage significantly increases (by the sum of ΔV1 plus ΔV2).

An example of pairings of a lower output gray LG and an upper output gray UG based on the range of the gray voltage shown by the line L1 of FIG. 5 is shown in FIG. 6. As shown in FIG. 6, since the lower output gray LG having a lower value and the upper output gray UG having a higher value are selected (paired), the interval between the lower output gray LG and the upper output gray UG becomes wider. The lower output gray LG and the upper output gray UG are selected (paired) based on the values stored in the lookup table 602 shown in FIG. 1 corresponding with the input gray.

FIG. 7 is a graph illustrating an average front-side gamma curve S1 and an average lateral-side gamma curve S2 of the lower output gray and the upper output gray of FIG. 6 when the range of the gray voltage is corrected according to the present invention, and an average front-side gamma curve S1′ and an average lateral-side gamma curve S2′ when the range of the gray voltage is not corrected.

As shown in FIG. 7, it can be seen from the average lateral-side gamma that the curve S2 has a shape similar to that of the average front-side gamma curve S1. As shown in FIG. 7, when comparing the average lateral-side gamma curves S2 and S2′, since the average lateral-side gamma curve S2 according to the present invention approaches the average front-side gamma curve S1 than the average lateral-side gamma curve S2′, it can be seen that a visibility index can be improved. The visibility index according to the average front-side gamma curve S1 and the average lateral-side gamma curve S2 according to the present invention is about 0.208, while the visibility index according to the front-side gamma curve S1′ and the lateral-side gamma curve S2′ is about 0.242. Here, the visibility index represents the degree to which a screen is not changed when viewing the screen with the naked eye, as a number. Thus, by changing a distortion amount of the lateral-side gamma to the front-side gamma in each gray, the changed amount is measured and represented by the number. At this scale, a low visibility index is good.

Since the gray voltage corresponding to the low gray group has a value less than the liquid crystal threshold voltage Vth and the value of the driving voltage Vdd increases to increase the value of the gray voltage corresponding to the high gray group, the range of the gray voltage becomes wider. Accordingly, since the range of the data voltage that can be applied becomes wider, the response speed of the liquid crystal may be improved by adjusting the data voltages.

Since the liquid crystal threshold voltage is generally temperature-dependent to a rather high extent, it may also be possible to compensate for this dynamic variation by dynamically changing the values stored in the lookup table 602.

As described above, since the input gray is converted into a pair of lower and upper output grays which form a lateral-side gamma curve having the shape most similar to the front-side gamma curve (e.g., based on time average transmittance) and assigned to the pixel, deterioration of the image quality due to the visibility difference between the front side and the lateral side of the apparatus can be reduced.

In addition, since the lower limit and the upper limit of the gray voltage can be changed to increase the range of the gray voltage, the selected range of the data voltage becomes wider. Accordingly, since the data voltage that can arrange the actual liquid crystal molecules in a desired state is selected and applied, the response speed of the liquid crystal increases and the image quality is improved.

Although the exemplary embodiments and the modified examples of the present invention have been described, the present invention is not limited to the embodiments and examples, but may be modified in various forms without departing from the scope of the appended claims and such modifications are within the scope of the present invention.

What is claimed is:

1. A liquid crystal display device, comprising:
a data processor configured to select a first output gray level and a second output gray level based on an input gray level of a received input image data, the first and second gray levels are applied to respective pixels of the liquid crystal display as corresponding first and second gray voltages;
a gray voltage generator configured to generate a plurality of gray reference voltages, wherein at least one of the plurality of gray reference voltages has a value less than a threshold voltage of the liquid crystal display.

2. The device according to claim 1, wherein the second output gray level is lower than the first output gray level.

3. The device of claim 1, wherein the range of the plurality of gray reference voltages is gray 0 to gray 255.

4. The device of claim 3, wherein the gray reference voltages corresponding to the range of gray 0 to gray 180 among the plurality of 256 gray reference voltages have voltages less than the liquid crystal threshold voltage.

5. The device of claim 3, wherein at least one of the plurality of gray reference voltages corresponds to the gray corresponding to a saturation region.

6. The device of claim 5, wherein the range of the grays corresponding to the saturation region includes gray 230 to gray 255.

7. The device of claim 5, wherein a percent change of transmittance (%) per voltage V applied to the liquid crystal in the saturation region is equal to or less than 20%/V.

8. The device of claim 1, wherein the gray voltage generator includes a plurality of resistors connected in series to a driving voltage.

9. The device of claim 8, wherein the resistance values of the resistors control the value of each of the plurality of gray reference voltages.

10. The device of claim 8, wherein the driving voltage controls the value of each of the plurality of gray reference voltages.

11. The device of claim 1, having an average lateral-side gamma curve similar to its front-side gamma curve.

12. The device of claim 1, wherein the first output gray level has a value greater than the input gray level.

13. The device of claim 1, wherein the second output gray level has a value less than the input gray level.

14. A display device comprising:
a pixel including a switching element; and
a data controller configured to generate a first digital output gray level and a second digital output gray level based upon one digital input gray level of received input image data.

15. The device of claim 14, wherein the second digital output gray level is lower than the first digital output gray level.

16. The device of claim 15, further comprising:
a data driver configured to output to the pixel, as data voltages, first and second gray voltages corresponding respectively to the first digital output gray level and to the a second digital output gray level.

17. The device of claim 16, wherein the first and second gray voltages are sequentially output to the pixel.

18. The device of claim 16, wherein the pixel includes a first subpixel and a second subpixel, and the first gray voltage is applied to the first subpixel and the second gray voltage is applied to the second subpixel.

19. The device of claim 16, wherein the data driver transmits the first output gray voltage as a first output image data and transmits the second output gray voltage as second output image data.

20. The device of claim 16, wherein the data driver sequentially transmits the first output gray voltage to the pixel and next transmits the second output gray voltage to the pixel.

21. The device of claim 16, further comprising:
a gate line configured to transmit gate signals to the switching element of the pixel;
a data line connected to the switching element configured to transmit at least one of first and second gray voltages from the data driver to the switching element of the pixel.

22. The device of claim 16, wherein the range of the digital output gray levels is gray 0 to gray 255.

23. The device of claim 14, further comprising:
a gray voltage generator electrically coupled to the data driver and configured to generate a plurality of gray reference voltages, wherein each of the first and second gray voltages output by the data driver is a selection from among the plurality of gray reference voltages.

24. The device of claim 23, wherein at least one of the plurality of gray reference voltages has a value less than a liquid crystal threshold voltage.

25. The device of claim 24, wherein the gray reference voltages corresponding to gray 0 to gray 80 among the plurality of gray reference voltages have values less than the liquid crystal threshold voltage.

26. The device of claim 14, wherein at least one of the plurality of gray reference voltages corresponds to a saturation region.

27. The device of claim 26, wherein the range of the grays corresponding to the saturation region includes gray 230 to gray 255.

28. The device of claim 14, wherein a percent change amount of transmittance (%) per voltage V applied to liquid crystal in the saturation region is equal to or less than 20%/V.

29. The device of claim 23, wherein the approximate average of the first and second gray voltages output by the data driver are is displayed by the pixel.

30. The device of claim 29, wherein the average front-side transmittance of the pixel due to applying the first and second digital output gray level is substantially identical to front-side transmittance of the pixel due to applying the input gray level.

31. A method of driving a display including a pixel, the method comprising:
receiving a digital image data indicating the luminance (gray) level to be displayed by the pixel;
converting the digital image data into a pair of a first luminance (gray) level and second luminance (gray) level, wherein the first luminance (gray) level is lower than the second luminance (gray) level.

32. The method of claim 31, wherein the first luminance (gray) level and second luminance (gray) level are paired based upon values stored in a lookup table.

33. The method of claim 31, further comprising:
converting the first luminance (gray) level into a first analog gray voltage;
converting the first luminance (gray) level into a second analog gray voltage; and
conducting the first analog gray voltage and the second analog gray voltage to the pixel.

34. The method of claim 31, wherein the first analog gray voltage is conducted to the pixel before the second analog gray voltage is conducted to the pixel.

35. The method of claim 31, wherein the pixel includes a first subpixel and a second subpixel, and the first analog gray voltage is conducted to the first subpixel and the second analog gray voltage is conducted to the subpixel.

36. The method of claim 31, further comprising:
generating a plurality of gray reference voltages; wherein each of the first analog gray voltage and the second analog gray voltage is based upon a selection from the plurality of gray reference voltages.

37. The method of claim 35, wherein at least one of the plurality of gray reference voltages has a value less than a liquid crystal threshold voltage.
